(19) United States
(12) Patent Application Publication
(10) Pub. No.: US 2019/0129013 A1
(43) Pub. Date: May 2, 2019

(54) LIDAR SENSOR ASSEMBLY WITH DETECTOR GAP

(71) Applicant: Continental Automotive Systems, Inc., Auburn Hills, MI (US)

(72) Inventors: Patrick B. Gilliland, Santa Barbara, CA (US); Jan Michael Masur, Santa Barbara, CA (US); Heiko Leppin, Santa Barbara, CA (US)

(73) Assignee: Continental Automotive Systems, Inc., Auburn Hills, MI (US)

(21) Appl. No.: 15/794,548

(22) Filed: Oct. 26, 2017

(51) Int. Cl. G01S 7/486; G01S 17/93; G01S 7/481

(52) U.S. Cl. CPC G01S 7/4863; G01S 17/87; G01S 7/4811; G01S 17/936

(57) ABSTRACT

A lidar sensor assembly includes a first detector array having a plurality of light sensitive detectors each configured to receive light reflected from an object and produce an electrical signal in response to receiving the light. The lidar sensor assembly also includes a second detector array having a plurality of detectors configured to receive light reflected from an object and produce an electrical signal in response to receiving the light. A readout integrated circuit (“ROIC”) is bonded to the first detector array and the second detector array. A gap is formed between the first detector array and the second detector array.

### TECHNICAL FIELD

The technical field relates generally to lidar sensor assemblies and more specifically to a plurality of light sensitive detectors.

### BACKGROUND

Lidar sensor assemblies often utilize a plurality of light sensitive detectors. These detectors may be arranged in a generally rectangular array representing a “field of view” of the sensor. Such a detector array may be directly connected to an integrated circuit using a plurality of metallic bonds.

Unfortunately, the thermal expansion rates of the detector array and the integrated circuit may be different from one another. With a relatively large detector array, excessive strain may occur between the detector array and the integrated circuit due to the difference in thermal expansion rates, resulting in failure of all or part of the sensor.

As such, it is desirable to present a lidar sensor assembly that does not exhibit excessive strain. In addition, other desirable features and characteristics will become apparent from the subsequent summary and detailed description, and the appended claims, taken in conjunction with the accompanying drawings and this background.

### BRIEF SUMMARY

In one exemplary embodiment, a lidar sensor assembly includes a first detector array having a plurality of light sensitive detectors each configured to receive light reflected from an object and produce an electrical signal in response to receiving the light. The lidar sensor assembly also includes a second detector array having a plurality of detectors configured to receive light reflected from an object and produce an electrical signal in response to receiving the light. A readout integrated circuit (“ROIC”) is bonded to the first detector array and the second detector array. The first detector array is disposed adjacent the second detector array and forms a gap therebetween.

In one exemplary embodiment, a lidar sensor assembly includes a light source configured to produce an output of pulsed light. The lidar sensor assembly also includes a diffusion optic for diffusing the pulsed light into a field of view. A first detector array includes a plurality of light sensitive detectors each configured to receive the pulsed light reflected from an object in the field of view and produce an electrical signal in response to receiving the pulsed light. A second detector array includes a plurality of detectors configured to receive the pulsed light reflected from an object and produce an electrical signal in response to receiving the pulsed light. The lidar sensor assembly further includes a readout integrated circuit (“ROIC”) bonded to the first detector array and the second detector array. The first detector array is disposed adjacent the second detector array and forms a gap therebetween.

In one exemplary embodiment, a vehicle includes a lidar sensor assembly. The lidar sensor assembly includes a light source configured to produce an output of pulsed light. The lidar sensor assembly also includes a diffusion optic for diffusing the pulsed light into a field of view. A first detector array includes a plurality of light sensitive detectors each configured to receive the pulsed light reflected from an object in the field of view and produce an electrical signal in response to receiving the pulsed light. A second detector array includes a plurality of detectors configured to receive the pulsed light reflected from an object and produce an electrical signal in response to receiving the pulsed light. The lidar sensor assembly further includes a readout integrated circuit (“ROIC”) bonded to the first detector array and the second detector array. The first detector array is disposed adjacent the second detector array and forms a gap therebetween. The vehicle further includes at least one of a propulsion system, a steering system, and a braking system. A controller is in communication with the lidar sensor assembly and at least one of the propulsion system, the steering system, and the braking system. The controller is configured to at least partially control at least one of the propulsion system, the steering system, and the braking system in response to data received from the lidar sensor assembly.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a lidar sensor assembly according to one exemplary embodiment;

FIG. 2 is a top view of a plurality of detector arrays of the lidar sensor assembly according to one exemplary embodiment;

FIG. 3 is a cross-sectional view of the plurality of detector arrays and a readout integrated circuit along line 3-3 in FIG. 2 according to one exemplary embodiment; and

FIG. 4 is an exploded view of the plurality of detector arrays and the readout integrated circuit according to one exemplary embodiment;

FIG. 5 is an exploded view of the plurality of detector arrays and the readout integrated circuit according to another exemplary embodiment;

FIG. 6 is a block diagram of a vehicle incorporating the lidar sensor assembly according to one exemplary embodiment; and

FIG. 7 is a detailed block diagram of the lidar sensor assembly according to one exemplary embodiment.

### DETAILED DESCRIPTION

Referring to the Figures, wherein like numerals indicate like parts throughout the several views, a lidar sensor assembly 100 is shown and described herein.

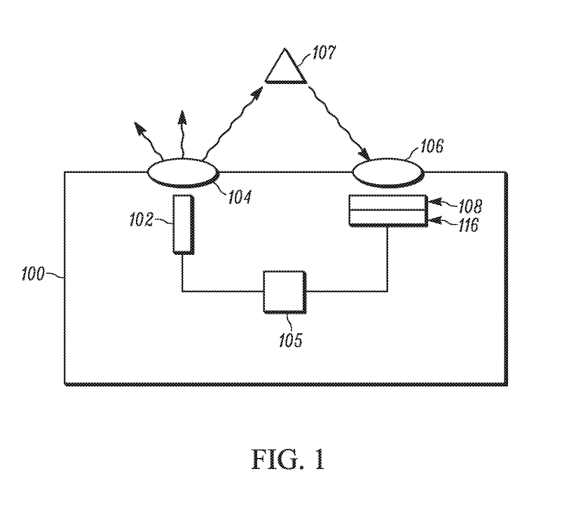

Referring to FIG. 1, the lidar sensor assembly 100 of the exemplary embodiment includes a light source 102. In the exemplary embodiment, the light source 102 includes a laser transmitter (not separately shown) configured to produce a pulsed laser light output. The laser transmitter may be a solid-state laser, monoblock laser, semiconductor laser, fiber laser, and/or an array of semiconductor lasers. It may also employ more than one individual laser. The pulsed laser light output, in the exemplary embodiment, has a wavelength in the infrared range. More particularly, the pulsed laser light output has a wavelength of about 1064 nanometers (nm). However, it should be appreciated that other wavelengths of light may be produced instead of and/or in addition to the 1064 nm light.

The lidar sensor assembly 100 may also include a diffusion optic 104 to diffuse the pulsed laser light output produced by the light source 102. The diffused, pulsed laser light output of the exemplary embodiment allows for the lidar sensor assembly 100 to operate without moving, e.g., rotating, the light source 102, as is often typical in prior art lidar sensors.

The lidar sensor assembly 100 may also include a controller 105 in communication with the light source 102. The controller 105 may include a microprocessor and/or other circuitry capable of performing calculations, manipulating data, and/or executing instructions (i.e., running a program). The controller 105 in the exemplary embodiment controls operation of the light source 102 to produce the pulsed laser light output.

The lidar sensor assembly 100 of the exemplary embodiment also includes a receiving optic 106, e.g., a lens (not separately numbered). Light produced by the light source 102 may reflect off one or more objects 107 and is received by the receiving optic 106. The receiving optic 106 focuses the received light into a focal plane. The focal plane is coincident with a plurality of light sensitive detectors 108. Each light sensitive detector 108 is each associated with a pixel (not shown) of an image (not shown). In the exemplary embodiment, each pixel measures about 135 μm×135 μm, giving each pixel a net pixel area of about 18.2 nm².

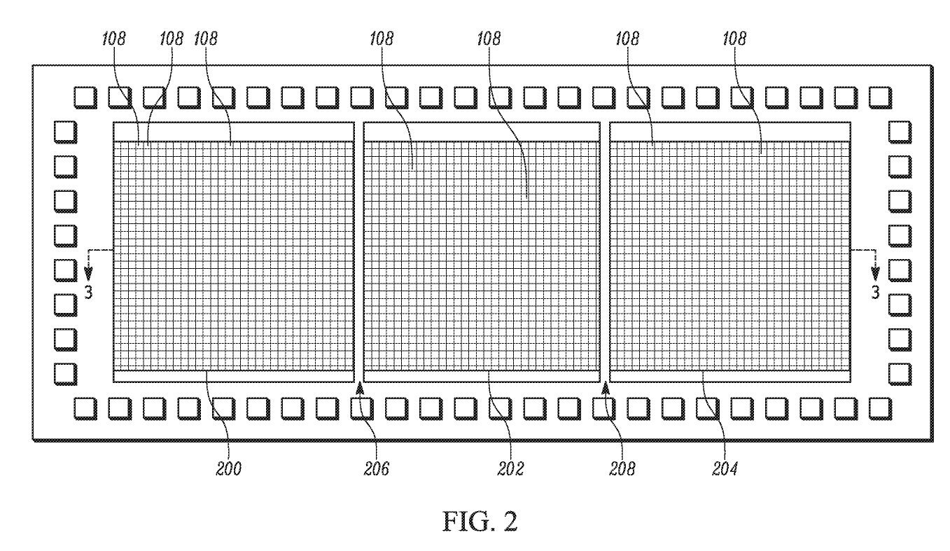

The light sensitive detectors 108 are arranged into at least two detector arrays 200, 202, 204, as shown in FIG. 2. In the exemplary embodiment, the lidar sensor assembly 100 includes three detector arrays 200, 202, 204: a first detector array 200, a second detector array 202, and a third detector array 204. However, it should be appreciated that in other embodiments, other number of detector arrays 200, 202, 204 may be implemented.

The light sensitive detectors 108 of each detector array 200, 202, 204 may be arranged into a plurality of rows (not numbered) and columns (not numbered). In the exemplary embodiment, a number of rows and columns of the first detector array 200 is the same as a number of rows and columns of the second detector array 202 and the third detector array 204. More particularly, in the exemplary embodiment described herein, each detector array 200, 202, 204 includes 4096 light sensitive detectors 108 arranged in a 64×64 array. That is, the light sensitive detectors 108 are arranged as 64 rows and 64 columns in a generally square shape. As such, each detector array 200, 202, 204 are generally identical to one another. However, it should be appreciated that the detector arrays 200, 202, 204 may include any number of light sensitive detectors 108 and be arranged in other shapes and configurations. It should also be appreciated that the various detector arrays 200, 202, 204 may be asymmetrical from one another and/or non-identical in other ways. In the exemplary embodiment, the pitch of the rows and columns is about 140 μm.

Each light sensitive detector 108 is configured to receive light produced by the light source 102 and reflected from at least one of the objects 107, as shown in FIG. 1. Each light sensitive detector 108 is also configured to produce an electrical signal in response to receiving the reflected light. The detectors 108 of the detector arrays 200, 202, 204 may be formed in a thin film of indium gallium arsenide (“InGaAs”) (not shown) deposited epitaxially atop an indium phosphide (“InP”) semiconducting substrate (not separately numbered).

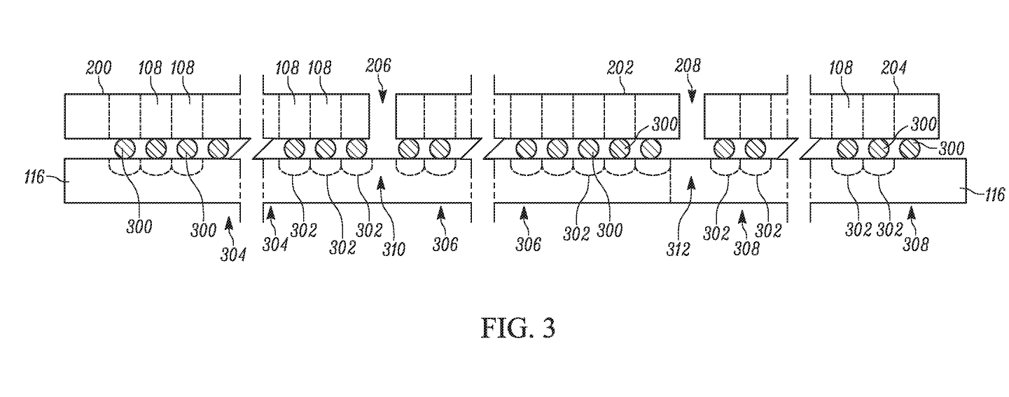

At least one readout integrated circuit (“ROIC”) 116 is bonded to the detector arrays 200, 202, 204, as shown in FIG. 1. More particularly, in the exemplary embodiment, as shown in FIG. 3, a plurality of indium bumps 300 electrically and mechanically connect the detector arrays 200, 202, 204 to the ROIC 116.

The ROIC 116 is formed with a silicon substrate (not separately numbered) and includes a plurality of unit cell electronic circuits (hereafter “unit cells” or “unit cell”) 302. In the exemplary embodiment, each unit cell 302 is associated with one of the light sensitive detectors 108 and receives the electrical signal generated by the associated light sensitive detector 108. Each unit cell 302 is configured to amplify the signal received from the associated light sensitive detector 102 and sample the amplified output. The unit cell 302 may also be configured to detect the presence of an electrical pulse in the amplified output associated with a light pulse reflected from the object 107. Of course, each unit cell 302 may be configured to perform functions other than those described above or herein. The unit cells 302 of the exemplary embodiment are arranged into a plurality of rows (not numbered) and columns (not numbered).

As stated above, in the exemplary embodiment, the detector arrays 200, 202, 204 have a substrate comprising indium phosphide while the ROIC 116 includes a substrate comprising silicon. As such, a coefficient of thermal expansion of the detector arrays 200, 202, 204 may be different from a coefficient of thermal expansion of the ROIC 116.

Therefore, the detector arrays 200, 202, 204 may expand or contract based on changes in temperature and/or pressure at a different rate than the ROIC 116. More particularly, in the exemplary embodiment, the coefficient of thermal expansion (“CTE”) of Indium Phosphide is 4.6 μm/m-° C. while the CTE of silicon is 3.0 μm/m-° C.

Referring to FIGS. 2 and 3, the first detector array 200 is disposed adjacent the second detector array 202 and forms a first gap 206 therebetween. In the exemplary embodiment, the third detector array 204 is disposed adjacent the second detector array 202 and forms a second gap 208 therebetween.

By utilizing gaps 206, 208, that is, spacing, between the detector arrays 200, 202, 204, the detector arrays 200, 202, 204 may expand and/or contract with differences in temperature and pressure. As such, strain on the detector arrays 200, 202, 204 and the bonds, e.g., the indium bumps 300, is reduced in comparison to a single detector array (not shown) where no gaps are used. More particularly, strain is reduced 3:1 over the prior art where one detector array is utilized. The reduction in strain yields a reduction in failure of all or a portion of the lidar sensor assembly 100, when compared to use of a larger, single detector array. Furthermore, assembly time of the lidar sensor assembly 100 may be reduced by using three 64×64 arrays 200, 202, 204, instead of one larger 192×64 array.

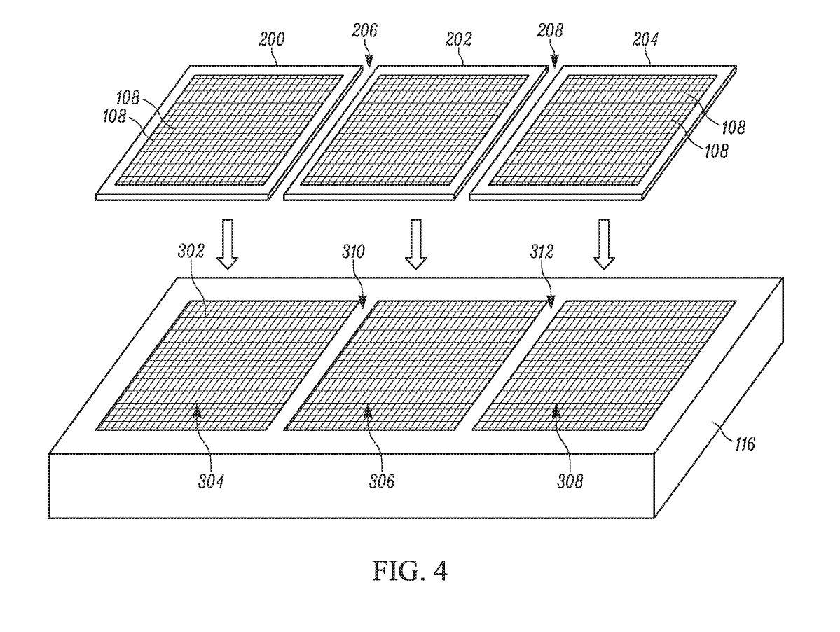

In one exemplary embodiment, as shown in FIGS. 3 and 4, the ROIC 116 is arranged into a first section 304, a second section 306, and a third section 308. A first space 310 is formed between the first section 304 and the second section 306 and a second space 312 is formed between the second section 306 and the third section 308. In the exemplary embodiment, each space 310, 312 has a width of about 35 μm. As such, two dark lines (not shown) having a width of about 35 μm will be present in the resulting image.

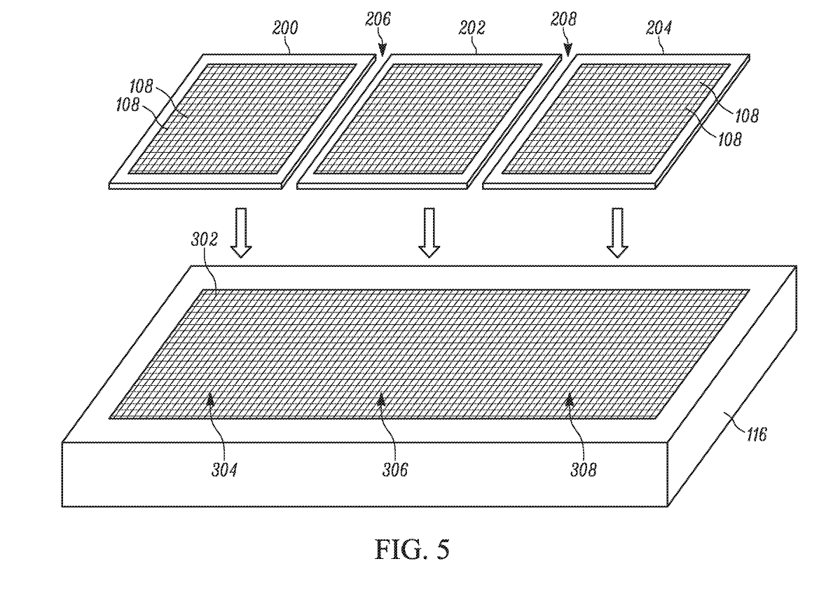

Another exemplary embodiment of the ROIC 116 is shown in FIG. 5. In this embodiment, the sections 304, 306, 308 are continuous; i.e., there is no spacing between the sections 304, 306, 308. In this embodiment, the area of the pixels corresponding to the edge columns of detectors 108, i.e., the detectors 108 adjacent the gaps 206, 208, will be reduced. Specifically, in this exemplary embodiment, these edge column pixels have dimensions of about 135 μm×105 μm. This provides a net pixel area that is 78% of the net pixel area of detectors 108 which are not adjacent to the gaps 206, 208.

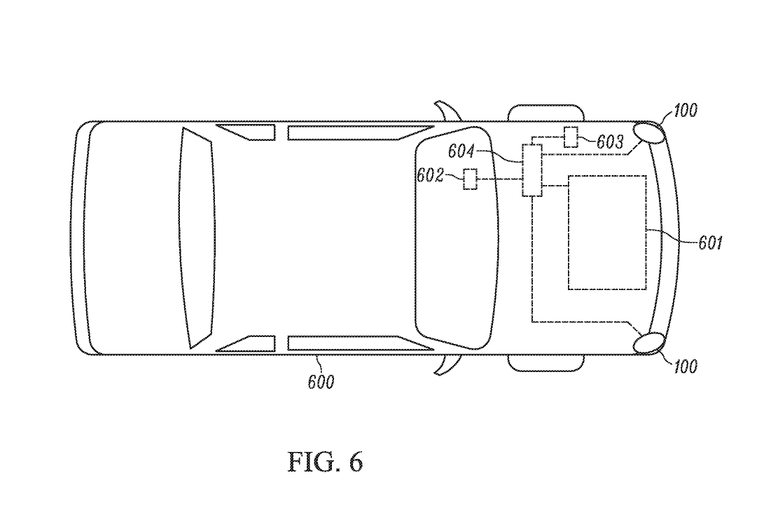

Referring now to FIG. 6, a vehicle 600, such as an automobile (not separately numbered) may incorporate at least one lidar sensor assembly 100, as described herein. The vehicle 600 of the exemplary embodiment includes a propulsion system 601, a steering system 602, and a braking system 603. The propulsion system 602 may include, but is certainly not limited to, an engine (not shown), a motor (not shown), and a transmission (not shown), for propelling the vehicle 600. The braking system 603 may include one or more brakes to slow one or more wheels of the vehicle 600. The steering system 602 controls the direction of travel of the vehicle 600 by, e.g., turning one or more wheels of the vehicle 600.

The vehicle 600 may also include a controller 604. The controller 604 is in communication with the at least one lidar sensor assembly 100. The controller 604 is also in communication with at least one of the propulsion system 601, the steering system 602, and the braking system 603. As such, the controller 604 may utilize data received from the at least one lidar sensor assembly 100 to control operation of the vehicle 600 via the propulsion system 601, the steering system 602, and/or the braking system 603.

For instance, one of the lidar sensor assemblies 100 may detect that an object 107, i.e., an obstruction such as another vehicle, a pedestrian, etc., lies in the forward driving path of the vehicle 600. The controller 604 may instruct the braking system 603 to apply the brakes to avoid a collision with the object 107. Alternatively and/or additionally, the controller 604 may instruct the steering system 602 to maneuver the vehicle 600 around the object 107.

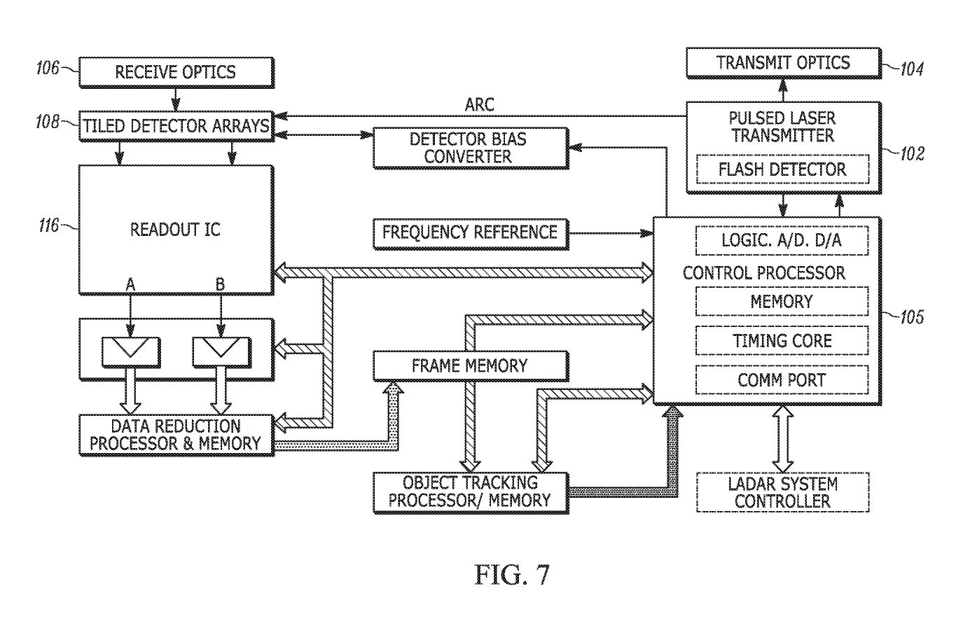

FIG. 7 shows a more detailed block diagram of the lidar sensor assembly 100 according to one exemplary embodiment. This embodiment is detailed in U.S. Pat. No. 9,420,264, which is hereby incorporated by reference.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly comprising:
a first detector array having a plurality of light sensitive detectors each configured to receive light reflected from an object and produce an electrical signal in response to receiving the light;
a second detector array having a plurality of detectors configured to receive light reflected from an object and produce an electrical signal in response to receiving the light; and
a readout integrated circuit (“ROTC”) bonded to said first detector array and said second detector array;
said first detector array disposed adjacent said second detector array forming a gap therebetween.

2. The lidar sensor assembly as set forth in claim 1, wherein a coefficient of thermal expansion of said first detector array and said second detector array is different from a coefficient of thermal expansion of said ROTC.

3. The lidar sensor assembly as set forth in claim 2, wherein said first detector array and said second detector array each have a substrate comprising indium phosphide.

4. The lidar sensor assembly as set forth in claim 3, wherein said semiconductor has a substrate comprising silicon.

5. The lidar sensor assembly as set forth in claim 1, wherein said light sensitive detectors of said first detector array are arranged into a plurality of rows and columns and said light sensitive detectors of said second detector array are arranged into a plurality of rows and columns.

6. The lidar sensor assembly as set forth in claim 5 wherein a number of rows and columns of said first detector array is the same as a number of rows and columns of said second detector array.

7. The lidar sensor assembly as set forth in claim 1, wherein said ROIC includes a plurality of unit cells arranged into a plurality of rows and columns with each unit cell corresponding to one of the light sensitive detectors.

8. The lidar sensor assembly as set forth in claim 7, wherein said plurality of unit cells of said ROIC are arranged into a first section and a second section with a space formed therebetween.

9. The lidar sensor assembly as set forth in claim 1, further comprising:
a third detector array having a plurality of light sensitive detectors configured to receive light reflected from an object and produce an electrical signal in response to receiving the light;
said ROIC bonded to said third detector array; and
said third detector array disposed adjacent second detector array forming a second gap therebetween.

10. The lidar sensor assembly as set forth in claim 9, wherein said light sensitive detectors of said first detector array, said second detector array, and said third detector array are each arranged into a plurality of rows and columns.

11. The lidar sensor assembly as set forth in claim 10, wherein a number of rows and columns of each detector array is the same.

12. A lidar sensor assembly comprising:
a light source configured to produce an output of pulsed light;
a diffusion optic for diffusing the pulsed light into a field of view;
a first detector array having a plurality of light sensitive detectors each configured to receive the pulsed light reflected from an object in the field of view and produce an electrical signal in response to receiving the pulsed light;
a second detector array having a plurality of detectors configured to receive the pulsed light reflected from an object and produce an electrical signal in response to receiving the pulsed light; and
a readout integrated circuit (“ROTC”) bonded to said first detector array and said second detector array;
said first detector array disposed adjacent said second detector array forming a gap therebetween.

13. The lidar sensor assembly as set forth in claim 12, wherein a coefficient of thermal expansion of said first detector array and said second detector array is different from a coefficient of thermal expansion of said ROTC.

14. The lidar sensor assembly as set forth in claim 13, wherein said first detector array and said second detector array each have a substrate comprising indium phosphide.

15. The lidar sensor assembly as set forth in claim 14, wherein said semiconductor has a substrate comprising silicon.

16. The lidar sensor assembly as set forth in claim 12, wherein said ROTC includes a plurality of unit cells arranged into a plurality of rows and columns with each unit cell corresponding to one of the light sensitive detectors.

17. The lidar sensor assembly as set forth in claim 16 wherein said plurality of unit cells of said ROTC are arranged into a first section and a second section with a space formed therebetween.

18. A vehicle, comprising:
a lidar sensor assembly, including
a light source configured to produce an output of pulsed light,
a diffusion optic for diffusing the pulsed light into a field of view,
a first detector array having a plurality of light sensitive detectors each configured to receive the pulsed light reflected from an object in the field of view and produce an electrical signal in response to receiving the pulsed light,
a second detector array having a plurality of detectors configured to receive the pulsed light reflected from an object and produce an electrical signal in response to receiving the pulsed light, and
a readout integrated circuit (“ROTC”) bonded to said first detector array and said second detector array,
said first detector array disposed adjacent said second detector array forming a gap therebetween;
at least one of a propulsion system, a steering system, and a braking system; and
a controller in communication with said lidar sensor assembly and at least one of said propulsion system, said steering system, and said braking system and configured to at least partially control at least one of said propulsion system, said steering system, and said braking system in response to data received from said lidar sensor assembly.

19. The vehicle as set forth in claim 18, wherein a coefficient of thermal expansion of said first detector array and said second detector array is different from a coefficient of thermal expansion of said ROTC.

20. The vehicle as set forth in claim 18, wherein
said ROTC includes a plurality of unit cells arranged into a plurality of rows and columns with each unit cell corresponding to one of the light sensitive detectors; and
said plurality of unit cells of said ROTC are arranged into a first section and a second section with a space formed therebetween.
